(19) United States
(12) Patent Application Publication
(10) Pub. No.: US 2021/0125249 A1
(43) Pub. Date: Apr. 29, 2021

(54) SYSTEM AND METHOD FOR QUOTING CONNECTIVITY SERVICES

(71) Applicant: Cataworx, Inc., Boulder, CO (US)

(72) Inventor: Luis Adolfo Perez-Duran, Boulder, CO (US)

(73) Assignee: Cataworx, Inc., Boulder, CO (US)

(21) Appl. No.: 17/078,248

(22) Filed: Oct. 23, 2020

Related U.S. Application Data
(60) Provisional application No. 62/924,692, filed on Oct. 23, 2019.

(51) Int. Cl. G06Q 30/06; G06Q 10/10; G06Q 30/02; H04L 12/24

(52) U.S. Cl. CPC G06Q 30/0611; G06Q 10/10; G06Q 30/0605; H04L 41/5032; G06Q 30/0206; H04L 41/5029; G06Q 30/0205

(57) ABSTRACT

Systems, methods and computer readable media for quoting connectivity services, including automatic pricing and quoting of connectivity services from multiple providers.

### CROSS REFERENCE TO RELATED APPLICATIONS

The present application claims the benefit to U.S. provisional patent application 62/924,692, filed Oct. 23, 2019, the contents of which are incorporated herein in their entirety.

### BACKGROUND OF THE INVENTION

The present invention relates to a system and method for pricing and quoting connectivity services.

The background description provided herein is for the purpose of presenting context to the disclosure. The materials described in the background section are not admitted to be prior art by inclusion in this section.

Each service provider generally has limited geographic coverage, for example a particular city, region or country, and so cannot offer worldwide connectivity services. Accordingly, service providers will provide portions of a connectivity service that are within their network, using their own network infrastructure. But the service within its own network will not be able to accommodate many desired geographically diverse connections.

A connectivity service connects one or more locations that may be geographically distributed. An example of such a connectivity service is connecting multiple business locations that are in different cities or even on different continents. A service provider, then, may provide portions of a connectivity service, while needing to set up agreements with other geographically diverse service providers in order to provide end-to-end connectivity services for a customer.

### SUMMARY OF THE INVENTION

Some embodiments relate generally to automated pricing and quoting of connectivity services (internet services, data transmission and/or private, enterprise services) where the pricing and quoting is for physically distributed portions of connectivity services, whether through providers of connectivity services or virtual providers of connectivity services or both. The pricing and quoting may be based on, for example, price and/or speed of distributed portions of the connectivity services. The pricing and quoting for physically distributed portions of the connectivity services may be achieved via interconnecting (chaining together) multiple connections or segments from different providers, which may include virtual providers, in order to obtain pricing and quoting for end-to-end connectivity services. Virtual providers may be service providers that do not own network assets but buy, modify, price and sell services to customers following a hierarchical relationship.

An advantage of an embodiment is that the automated pricing and quoting for end-to-end connectivity services (generally wholesale connectivity services) may be accomplished quickly, while still allowing for individual service providers to maintain some trade secrets with regard to specific pricing strategy for their own portion of the services being priced and quoted. That is, a quote may be submitted from a certain provider, but that provider's quote may include quotes from other service providers handling other geographic areas down the line from that particular provider. And, those service providers down the line from the particular provider may likewise include quotes from other service providers even farther down the line. In this way, automated pricing and quoting for end-to-end connectivity may be provided without individual providers giving up trade secret pricing strategies for their particular portion of the overall service. Moreover, the pricing and quoting may be accomplished quickly because the gathering and assembly of pricing and quotes is automated, thus minimizing human interaction for each particular quote.

An advantage of an embodiment is that conditions (parameters) may be placed on the pricing and quotes so that the terms are clear to those providing quotes for portions (segments) of the service as well as the customer—allowing for more a more robust automated quoting process. For example, the amount of time that the quote is still in effect may be set so that all parties know how long the customer has to accept or reject the quote. These parameters may be set in an algorithm so that all are automatically operating with the same parameters for each quote.

An advantage of an embodiment is that service providers (including virtual service providers) may operate from software operating on the service provider's own network equipment or service providers may employ software located in the cloud and still achieve the functionality needed to provide automated quoting each time a new quote is requested. This software may also set parameters for each service provider, for example, with which other service providers that particular service provider is allowed to connect. Such a methodology allows for pricing and quoting for service contracts facilitated by a decentralized automated system, while all providers are employing a common interactive software to communicate, thus minimizing errors or misunderstandings with pricing and quoting of services.

### BRIEF DESCRIPTION OF THE DRAWINGS

The Detailed Description will be readily understood in conjunction with the accompanying drawings, which are illustrated by way of example and not by way of limitation in the figures.

FIG. 1 is a schematic diagram illustrating an example of an interconnection of service providers that may be employed for recursively producing and assembling a quote, with geographically distributed service providers.

FIG. 2 is a schematic diagram illustrating an example of an interconnection of service providers that may be employed for recursively producing and assembling a quote, via a hierarchy of virtual service providers.

FIG. 3 is a schematic diagram illustrating an example of an overall structure for interconnection of service providers (including virtual service providers) that may be employed for recursively producing and assembling a quote, via geographically distinct and/or virtual service providers.

FIG. 4 is a schematic diagram illustrating an example of an overall computing system that may carry out the automated pricing and quoting for service connectivity from various service providers.

FIG. 5 schematically illustrates an example of non-transitory computer readable storage media, employed in the execution of automated pricing and quoting for service connectivity from various service providers.

FIG. 6 is a flow chart illustrating an example of process steps relating to operations of one or more quoting nodes.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail.

Further, various operations will be described as multiple discrete operations, in turn, in a manner that is most helpful in understanding the illustrative embodiments; however, the order of description should not be construed as to imply that these operations are necessarily order dependent. In particular, these operations may not be performed in the order of presentation.

The description may use the phrases “in an embodiment,” “in embodiments,” “in some embodiments,” and/or “in various embodiments,” which may each refer to one or more of the same or different embodiments. Furthermore, the terms “comprising,” “including,” “having,” and the like, as used with respect to embodiments of the present disclosure, are synonymous.

The phrase “A and/or B” means (A), (B), or (A and B). The phrases “A/B” and “A or B” mean (A), (B), or (A and B), similar to the phrase “A and/or B.” For the purposes of the present disclosure, the phrase “at least one of A and B” means (A), (B), or (A and B).

As used hereinafter, including the claims, the term “unit,” “engine,” “module,” or “routine” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

Example embodiments may be described as a process depicted as a flowchart, a flow diagram, a data flow diagram, a structure diagram, or a block diagram. Although a flowchart may describe the operations as a sequential process, many of the operations may be performed in parallel, concurrently, or simultaneously. In addition, the order of the operations may be re-arranged. A process may be terminated when its operations are completed, but may also have additional steps not included in the figure(s). A process may correspond to a method, a function, a procedure, a subroutine, a subprogram, and the like. When a process corresponds to a function, its termination may correspond to a return of the function to the calling function and/or the main function.

Example embodiments may be described in the general context of computer-executable instructions, such as program code, software modules, and/or functional processes, being executed by one or more of the aforementioned circuitry. The program code, software modules, and/or functional processes may include routines, programs, objects, components, data structures, etc., that perform particular tasks or implement particular data types. The program code, software modules, and/or functional processes discussed herein may be implemented using existing hardware in existing communication networks. For example, program code, software modules, and/or functional processes discussed herein may be implemented using existing hardware at existing network elements or control nodes.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

The terms “coupled with” and “coupled to” and the like may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. By way of example and not limitation, “coupled” may mean two or more elements or devices are coupled by electrical connections on a printed circuit board such as a motherboard, for example. By way of example and not limitation, “coupled” may mean two or more elements/devices cooperate and/or interact through one or more network linkages such as wired and/or wireless networks. By way of example and not limitation, a computing apparatus may include two or more computing devices “coupled” on a motherboard or by one or more network linkages.

As used herein, the term “circuitry” refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD), (for example, a field-programmable gate array (FPGA), a programmable logic device (PLD), a complex PLD (CPLD), a high-capacity PLD (HCPLD), a structured ASIC, or a programmable System on Chip (SoC)), digital signal processors (DSPs), etc., that are configured to provide the described functionality. In some embodiments, the circuitry may execute one or more software or firmware programs to provide at least some of the described functionality.

As used herein, the term “interface” or “interface circuitry” may refer to, is part of, or includes circuitry providing for the exchange of information between two or more components or devices. The term “interface circuitry” may refer to one or more hardware interfaces (for example, buses, input/output (I/O) interfaces, peripheral component interfaces, network interface cards, and/or the like).

As used herein, the term “processor” may refer to, is part of, or includes circuitry capable of sequentially and automatically carrying out a sequence of arithmetic or logical operations; recording, storing, and/or transferring digital data. The term “processor” may refer to one or more application processors, one or more baseband processors, a physical central processing unit (CPU), and/or any other device capable of executing or otherwise operating computer-executable instructions, such as program code, software modules, and/or functional processes.

As used herein, the term “computer” may describe any physical hardware device capable of sequentially and automatically carrying out a sequence of arithmetic or logical operations, equipped to record/store data on a machine readable medium, and transmit and receive data from one or more other devices in a communications network. A computer may be considered synonymous to, and may hereafter be occasionally referred to, as a computing platform, computing device, etc. The term “computer” may include any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

Examples of “computers” may include cellular phones or smart phones, feature phones, tablet personal computers, wearable computing devices, an autonomous sensors, laptop computers, desktop personal computers, video game consoles, digital media players, handheld messaging devices, personal data assistants, augmented reality devices, server computer devices, cloud computing services/systems, network elements, embedded systems, microcontrollers, control modules, machine-type communications (MTC) devices, machine-to-machine (M2M), Internet of Things (IoT) devices, and/or any other like electronic devices.

As used herein, the term “network” may be considered synonymous to and/or referred to as a networked computer, networking hardware, network equipment, router, switch, hub, bridge, radio network controller, radio access network device, gateway, server, and/or any other like device. The term “network” may describe a physical computing device of a wired or wireless communication network and be configured to host a virtual machine. Furthermore, the term “network” may describe equipment that provides radio baseband functions for data and/or voice connectivity between a network and one or more users.

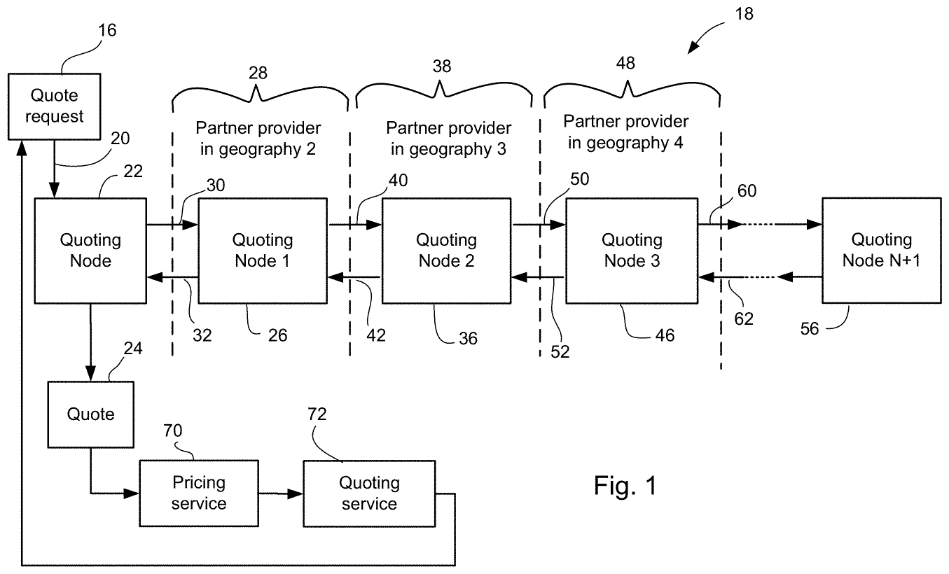

FIG. 1 illustrates an example of an interconnection of service providers that may be employed for recursively producing and assembling a quote, with geographically distributed service providers. A party 16 desiring connectivity services may request a quote 20 for services from a service provider 22, via its quoting node, connected to the automated pricing and quoting system 18. As used herein, connectivity services may include internet services, data transmission and/or private, enterprise services. The party, as used herein, may be an entity desiring to use the connectivity services or may be a quoting node, which are discussed below. The service provider 22 may offer its services within a particular geographic area (for purposes of discussion herein call the first geographic area). A service provider may be, for example, a telecom operator. If the service provider 22 can provide the requested services within its own network (within this first geographic area covered by the service provider 22), then the service provider 22 may automatically proceed to directly producing a quote 24. If not able to provide all of the requested services within its own network, then the service provider 22 automatically determines what other service provider(s) to contact that can provide the services in the desired geographic area(s) not covered by the service provider's 22 own network, and are geographically adjacent to the service provider's 22 network such that they have interconnected their networks. The determination as to which other adjacent service providers to contact may be based on factors already entered into the system's algorithms. For example, there may be ten possible providers to request quotes from but only one or two may receive requests for quoting based on factors such as general contracts in place between particular providers, the type of services being requested, and some knowledge of price differences between various possible providers.

In the example of FIG. 1, for simplicity in explanation, one partner provider 26 covering a second geographic region 28 automatically receives a request for quoting 30 in providing a portion of the services requested (outside of the service provider's 22 network). This first partner provider 26 can connect to the service provider's 22 network in order to allow for the desired connectivity for the party 16 requesting the connectivity services. That is, the partner service provider 26 is geographically contiguous (adjacent) with the service provider 22 and they have interconnected their networks to allow for the desired information flow. If this first partner provider 26 can provide the remainder of the connectivity services from within its own network, then the first partner provider 26 may automatically return a quote 32 to the service provider 22, in which case the service provider 22 may proceed to automatically producing a quote 24.

If this first partner provider 26 can supply only a portion of the remaining connectivity needed from within its own geographic region 28, then the first partner provider 26 automatically determines what other service providers to contact that can produce the services in the desired geographic area that is not already covered by the service provider 22 and first partner provider 26. The determination as to which other service providers to contact may be based on factors already entered into the system's algorithms. For example, there may be ten possible providers to request quotes from but only one or two may receive requests for quoting based on factors such as general contracts in place between particular providers, the type of services being requested, and some knowledge of price differences between various possible providers.

In the example of FIG. 1, for simplicity in explanation, a second partner provider 36 covering a third geographic region 38 automatically receives a request for quoting 40 in providing a portion of the services requested (outside of the service provider's 22 and first partner provider's 26 networks). This second partner provider 36 can connect to the service provider's 22 network, via the first partner provider's 26 network, in order to allow for the desired connectivity for the party 16 requesting the connectivity services. That is, the second partner service provider 36 is geographically contiguous with the first partner service provider 26, who as discussed above is geographically contiguous with the service provider 22 and they have interconnected their networks to allow for the desired information flow. The services requested may be represented by a standardized service code or codes that contain service and location attributes relating to the specifics of the services requested, further aiding in automating the pricing and quoting process. If this second partner provider 36 can provide the remainder of the connectivity services from within its own network, then the second partner provider 36 may automatically return a quote 42 to the first partner provider 26. The first partner provider 26 then automatically combines its quote for the services provided from its own network with the quote from the second partner provider 36 and returns a combined quote 32 to the service provider 22, in which case the service provider 22 may proceed to automatically producing a quote 24. In this way, the individual pricing strategy from each partner provider 26, 36 is not seen by the service provider 22, thus protecting individual trade secrets for the particular providers. This process of pricing and quoting also allows for anonymity for the second partner provider 36 from the service provider 22.

If this second partner provider 36 can supply only a portion of the remaining connectivity needed from within its own geographic region 38, then the second partner provider 36 automatically determines what other service providers to contact that can produce the services in the desired geographic area that is not already covered by the service provider 22, the first partner provider 26 and the second partner provider 36. The determination as to which other service providers to contact may be based on factors already entered into the system's algorithms. For example, there may be ten possible providers to request quotes from but only one or two may receive requests for quoting based on factors such as general contracts in place between particular providers, the type of services being requested, and some knowledge of price differences between various possible providers.

In the example of FIG. 1, for simplicity in explanation, a third partner provider 46 covering a fourth geographic region 48 automatically receives a request for quoting 50 in providing a portion of the services requested (outside of the service provider's 22, the first partner provider's 26 and the second partner provider's 36 networks). This third partner provider 46 can connect to the service provider's 22 network, via the first partner provider's 26 network and the second partner provider's 36 network, in order to allow for the desired connectivity for the party 16 requesting the connectivity services. That is, the third partner service provider 46 is geographically contiguous with the second partner service provider 36, and so forth, and they have interconnected their networks to allow for the desired information flow through the networks. If this third partner provider 46 can provide the remainder of the connectivity services from within its own network, then the third partner provider 46 may automatically return a quote 52 to the second partner provider 36. The second partner provider 36 then automatically combines its quote for the services provided from its own network with the quote from the third network provider 46 and returns a combined quote 42 to the first partner provider 26. The first partner provider 26 then automatically combines its quote for the services provided from its own network with the quote from the second partner provider 36 and returns a combined quote 32 to the service provider 22, in which case the service provider 22 may proceed to automatically producing a quote 24. In this way, the individual quoting strategy from each partner provider 26, 36, 46 is not seen by the service provider 22, thus protecting individual trade secrets for the particular providers. For example, the third partner provider 46 may have anonymity from the first partner provider 26 and the service provider 22.

If this third partner provider 46 can supply only a portion of the remaining connectivity needed from within its own geographic region 48, then the third partner provider 46 automatically determines what other service providers to contact that can produce the services in the desired geographic area that is not already covered by the service provider 22, the first partner 26, the second partner 36 and the third partner 46. The determination as to which other service providers to contact may be based on factors already entered into the system's algorithms. For example, there may be ten possible providers to request quotes from but only one or two may receive requests for quoting based on factors such as general contracts in place between particular providers, the type of services being requested, and some knowledge of price differences between various possible providers.

This quoting 60, 62 is then carried out as discussed above out to the N+1 provider 56. The N+1 provider 56 may be the last provider needed to complete the connectivity requested by the party 16 to obtain the needed connectivity across various geographically dispersed networks. In this example the quote is recursively returned to the service provider 22 and finally to the requesting party 16. The request for connectivity services may also have a hop counter set by, for example the party 16 or the service provider 22, which sets a maximum limit for the number of interconnected service providers. In this case, if the hop count is met before the connectivity desired by the party 16 is met, then the process of requesting quotes from interconnected partners stops and the response is returned to the immediately previous requesting party, which in turn returns a response to its immediately previous requesting party. The process continues until the party 16 receives a quote or an indication that the service couldn't be quoted by this service provider 22. The hop counter not only controls the depth of the search for connectivity quoting, but also prevents loops among the service partners—that is, while the quoting in FIG. 1 is shown as linear for simplicity, there can be many interconnected service partners that have various contracts with each other in what amounts to more of a graph (matrix) of providers.

When the quoting for the complete connectivity requested by the party 16 is met, the price quote 24 is automatically assembled, and then automatically sent to a pricing service 70, which may for example automatically determine adjustments, such as markup on the overall price, or other conditions on the quote. The pricing service 70 then automatically sends this information to the quoting service 72, which returns the quote to the party 16 requesting the connectivity services. Each quoting node may have its own pricing service and its own quoting service, allowing each node to operate as the service provider for any particular quote request.

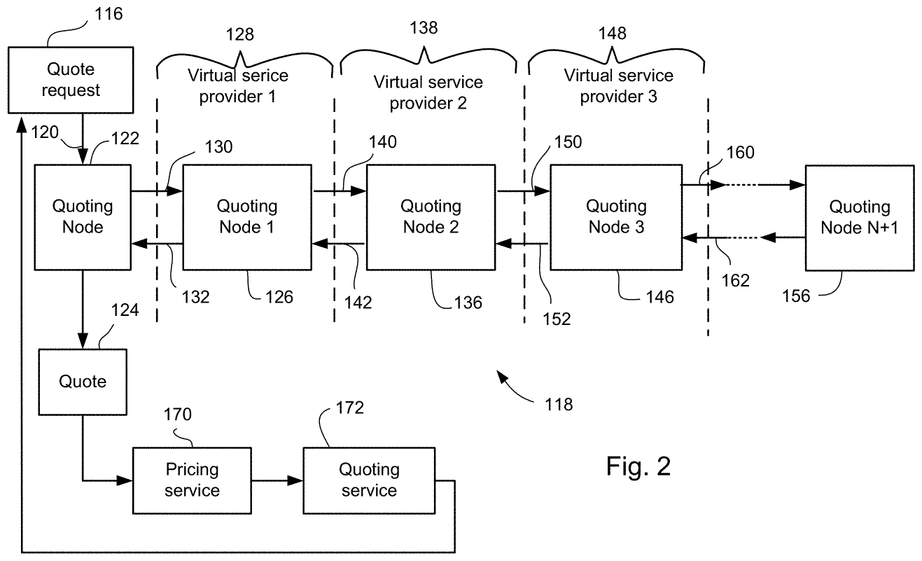

FIG. 2 illustrates an example of an interconnection of service providers that may be employed for recursively producing and assembling a quote, with virtual service providers providing at least a portion of the geographically distributed service. A party 116 desiring connectivity services may request a quote 120 for services from a service provider 122, via its quoting node, connected to the automated pricing and quoting system 118. This service provider may be a virtual service provider or a service provider that has its own network (covering a particular geographic area-first geographic area). Virtual providers may be service providers that do not own network assets but buy/rent, modify, price and sell connectivity services (i.e., resellers) to customers following a hierarchical relationship. If the service provider 122 can provide the services within its own network (within this first geographic area covered by the service provider 122), then the service provider 122 may automatically proceed to directly producing a quote 124. If not able to provide the services within its network, then the service provider 122 automatically determines what other service provider(s) to contact that can provide the services in the desired geographic area(s) not covered by the service provider's 122 network, and are geographically adjacent to the service provider's 122 network such that they have interconnected their networks. The determination as to which other adjacent service providers to contact may be based on factors already entered into the system's algorithms. For example, there may be ten possible providers to request quotes from but only one or two may receive requests for quoting based on factors such as general contracts in place between particular providers, the type of services being requested, and some knowledge of price differences between various possible providers.

In the example of FIG. 2, for simplicity in explanation, one virtual partner provider 126 covering a second geographic region 128 automatically receives a request for quoting 130 in providing a portion of the services requested (outside of the service provider's 122 network). This first partner provider 126 can connect to the service provider's 122 network, via networks that the virtual provider has purchased/rented, in order to allow for the desired connectivity for the party 116 requesting the connectivity services. That is, the partner service provider 126 has contracted for network assets that are geographically contiguous (adjacent) with the service provider 122 and are interconnected to allow for the desired information flow. If this first partner provider 126 can provide the remainder of the connectivity services from within its virtual network, then the first partner provider 126 may automatically return a quote 132 to the service provider 122, in which case the service provider 122 may proceed to automatically producing a quote 124.

If this first partner provider 126 can supply only a portion of the remaining connectivity needed from within its virtual geographic region 128, then the first partner provider 126 automatically determines what other service providers to contact that can produce the services in the desired geographic area that is not already covered by the service provider 122 and first partner 126. The determination as to which other service providers to contact may be based on factors already entered into the system's algorithms. For example, there may be ten possible providers to request quotes from but only one or two may receive requests for quoting based on factors such as general contracts in place between particular providers, the type of services being requested, and some knowledge of price differences between various possible providers.

In the example of FIG. 2, for simplicity in explanation, a second virtual partner provider 136 covering a third geographic region 138 automatically receives a request for quoting 140 in providing a portion of the services requested (outside of the service provider's 122 network and first partner provider's 126 virtual network). This second partner provider 136 can connect to the service provider's 122 network, via the first partner provider's 126 virtual network, in order to allow for the desired connectivity for the party 116 requesting the connectivity services. That is, the second partner service provider 136 has contractually purchased/rented a network geographically contiguous with the first partner service provider 126, who as discussed above is geographically contiguous with the service provider 122 and they have network connections to allow for the desired information flow. While this second partner provider 136 is discussed as a virtual provider for purposes of discussing FIG. 2, this second partner provider 136 may be a service provider that is not virtual (i.e., the connectivity is on its own network) and just connects to the virtual provider 126 back to the service provider. Thus, as the automated pricing and quoting process progresses, there may be a mix of connectivity providers that own and control their networks and virtual service providers, with the end result being the pricing and quoting of connectivity requested by the party 116. This intermixing of virtual and not-virtual providers may be further assisted in that the services requested may be represented by a standardized service code or codes that contain service and location attributes relating to the specifics of the services requested, further aiding in automating the pricing and quoting process.

If this second partner provider 136 can provide the remainder of the connectivity services from within the network under contract, then the second partner provider 136 may automatically return a quote 142 to the first partner provider 126. The first partner provider 126 then automatically combines its quote for the services provided from the network under its contract with the quote from the second partner provider 136 and returns a combined quote 132 to the service provider 122, in which case the service provider 122 may proceed to automatically producing a quote 124. In this way, the individual pricing strategy from each partner provider 126, 136 is not seen by the service provider 122, thus protecting individual trade secrets for the particular providers, whether virtual or not. This process of pricing and quoting also allows for anonymity for the second partner provider 136 from the service provider 122.

If this second partner provider 136 can supply only a portion of the remaining connectivity needed from within its contracted geographic region 138, then the second partner provider 136 automatically determines what other service providers, whether virtual or not, to contact that can produce the services in the desired geographic area that is not already covered by the service provider 122, the first partner 126 and the second partner 136. The determination as to which other service providers to contact may be based on factors already entered into the system's algorithms. For example, there may be ten possible providers to request quotes from but only one or two may receive requests for quoting based on factors such as general contracts in place between particular providers, the type of services being requested, and some knowledge of price differences between various possible providers.

In the example of FIG. 2, for simplicity in explanation, a third virtual partner provider 146 covering a fourth geographic region 148 automatically receives a request for quoting 150 in providing a portion of the services requested (outside of the service provider's 122, the first partner provider's 126 and the second partner provider's 136 networks/virtual networks). This third partner provider 146 can connect to the service provider's 122 network, via the first partner provider's 126 network/virtual network and the second partner provider's 136 network/virtual network, in order to allow for the desired connectivity for the party 116 requesting the connectivity services. That is, the third partner service provider 146 is geographically contiguous with the second partner service provider 136, and so forth, and they have interconnected their networks/virtual networks to allow for the desired information flow through the networks. If this third partner provider 146 can provide the remainder of the connectivity services from within its own network, then the third partner provider 146 may automatically return a quote 152 to the second partner provider 136. The second partner provider 136 then automatically combines its quote for the services provided from its network/virtual network with the quote from the third network provider 146 and returns a combined quote 142 to the first partner provider 126. The first partner provider 126 then automatically combines its quote for the services provided from its network/virtual network with the quote from the second partner provider 136 and returns a combined quote 132 to the service provider 122, in which case the service provider 122 may proceed to automatically producing a quote 124. In this way, the individual pricing strategy from each partner provider 126, 136, 146 is not seen by the service provider 122, thus protecting individual trade secrets for the particular providers. For example, the third partner provider 146 may have anonymity from the first partner provider 126 and the service provider 122.

If this third partner provider 146 can supply only a portion of the remaining connectivity needed from within its geographic region 148 under contract, then the third partner provider 146 automatically determines what other service providers to contact that can produce the services in the desired geographic area that is not already covered by the service provider 122, the first partner 126, the second partner 136 and the third partner 146. The determination as to which other service providers to contact may be based on factors already entered into the system's algorithms. For example, there may be ten possible providers to request quotes from but only one or two may receive requests for quoting based on factors such as general contracts in place between particular providers, the type of services being requested, and some knowledge of price differences between various possible providers.

This quoting 160, 162 is then carried out as discussed above out to the N+1 provider 156, which providers may own/control their own networks or operate virtual networks under contract. The N+1 provider 156 may be the last provider needed to complete the connectivity requested by the party 116 to obtain the needed connectivity across various geographically dispersed networks. In this example the quote is recursively returned to the service provider 122 and finally to the requesting party 116. The request for connectivity services may also have a hop counter set by, for example the party 116 or the service provider 122, which sets a maximum limit for the number of interconnected service providers. In this case, if the hop count is met before the connectivity desired by the party 116 is met, then the process of requesting quotes from interconnected partners stops and the response is returned to the immediately previous requesting party, which in turn returns a response to its immediately previous requesting party. The process continues until the party 116 receives a quote or an indication that the service couldn't be quoted by this service provider 122. The hop counter not only controls the depth of the search for connectivity quoting, but also prevents loops among the service partners—that is, while the quoting in FIG. 2 is shown as linear for simplicity, there can be many interconnected service partners that have various contracts with each other in what amounts to more of a graph (matrix) of providers.

When the quoting for the complete connectivity requested by the party 116 is met, the price quote 124 is automatically assembled, and then automatically sent to a pricing service 170, which may for example automatically determine adjustments, such as markup on the overall price, or other conditions on the quote. The pricing service 170 then automatically sends this information to the quoting service 172, which returns the quote to the party 116 requesting the connectivity services. Each quoting node may have its own pricing service and its own quoting service, allowing each node to operate as the service provider for any particular quote request.

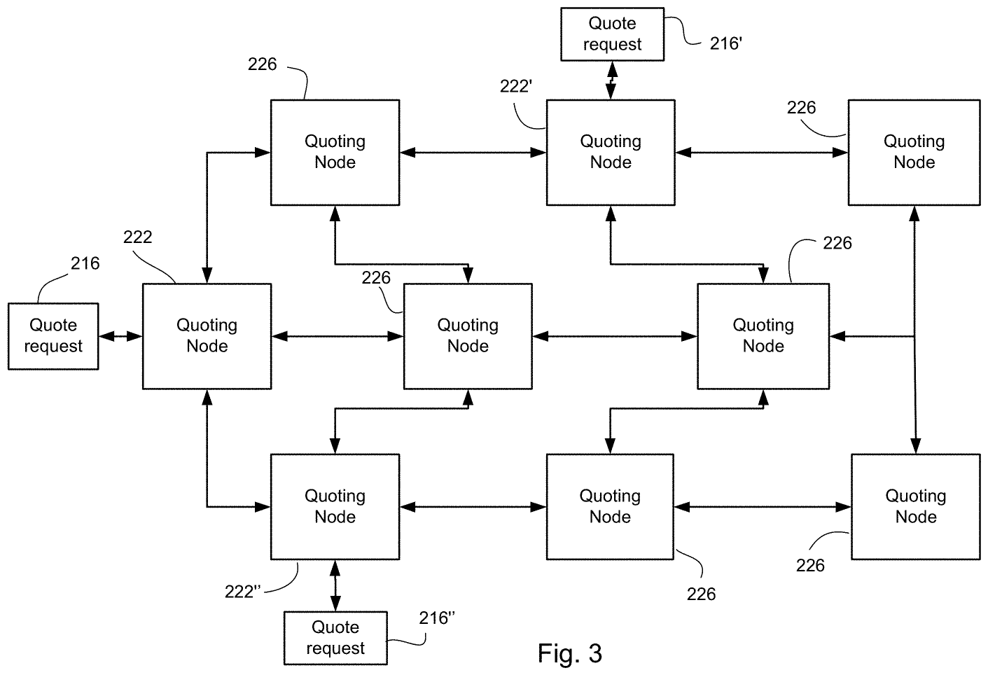

FIG. 3 illustrates an example of an overall structure for interconnection of service providers (including virtual service providers) that may be employed for recursively producing and assembling a quote, via geographically distinct and/or virtual service providers. This overall structure illustrating pricing and quoting of a connectivity service request incorporates the pricing and quoting as discussed relative to FIGS. 1 and 2, while showing that the actual overall structure for the pricing and quoting of connectivity services is not necessarily just linear as shown in FIGS. 1 and 2, but may be more of a graph (matrix) of potential providers involved with achieving the connectivity requested by the party 216. One will also note that once any one or more of the service provider(s) (e.g., 222, 222′ or 222″) are connected into the system and are allowed to be one of the nodes that begins a pricing and quoting process, that the connectivity request from a party may start at various nodes (e.g., party 216, 216′ or 216″, respectively, which may be the user of the connectivity services or another quoting node). This allows for distributed pricing and quoting system without any need for centralized control. Each service provider may operate its own quoting node and enable access to its partner providers, without the need for any particular service provider to know about or connect with every other service provider. Accordingly, each quoting node may have its own pricing service and its own quoting service, allowing each node to operate as the service provider for any particular quote request.

The particular service provider 222, 222′, 222″ then automatically proceeds as discussed above relative to FIGS. 1 and 2 to determine if it can provide the connectivity services entirely by itself or if it needs to request quoting from service partner providers 226 (whether virtual or not). If a request from partner providers 226 is needed, then the process continues as discussed relative to FIGS. 1 and 2, with an automated decision as to which partner(s) to request a quote from. One will note that a service provider for a quote request from one party may be a partner provider for a quote request that begins at a different quoting node. The pricing and quoting process then continues as discussed relative to FIGS. 1 and 2 until the quoting for the service connectivity requested by the particular party is completed or the hop counter reaches its limit and stops the process for the quote requested by that particular party.

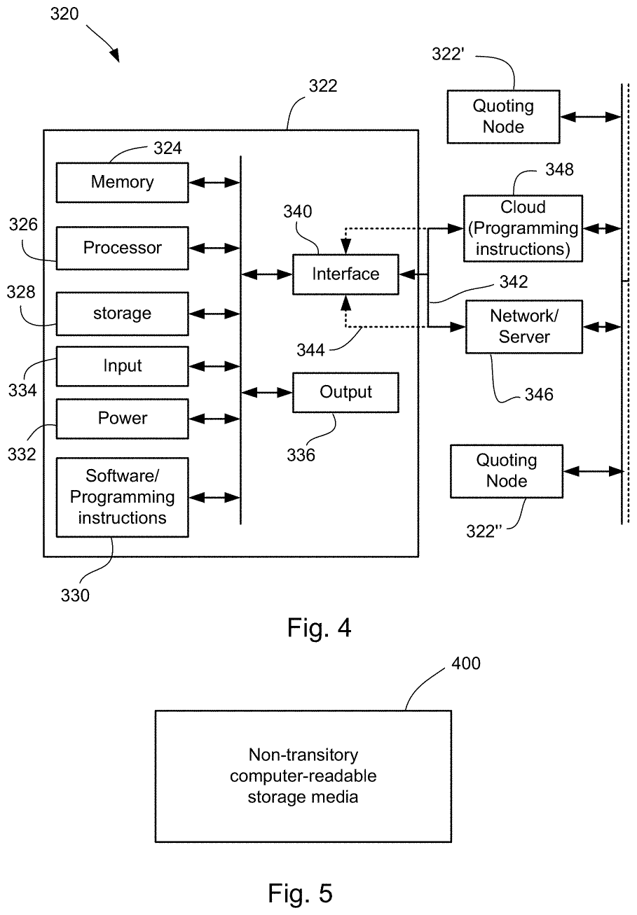

FIG. 4 illustrates an example of an overall computing system 320 that may carry out the automated pricing and quoting for service connectivity from various service providers. A quoting node 322 may include a power source 332 that operates with a processor 326, memory 324, data storage medium 328, data input mechanism 334, data output mechanism 336 and software/programming instructions 330 to carry out the operations of the quoting node 322. These elements of the processor 326, memory 324, storage 328, input 334 and output 336 may be made up of various combinations of hardware and software as is known to those skilled in the art. The processor 326 may be made up of a single processor, with single or multiple cores, or multiple processors in communication with one another to perform the processing functions. The memory 324 and storage 328 may be volatile or nonvolatile and may employ various forms of information storage mechanisms as are known in the art; and moreover, may store information locally or in cloud-based storage as is known in the art. The input 334 and output 336 devices may be any one of many interfaces known to those skilled in the art. Moreover, the quoting node 322 may take the form of a stationary (e.g., a desktop computer, etc.) or mobile (e.g., tablet, smart phone, etc.) device.

Whether a stationary, virtual device and/or mobile device, the quoting node 322 may have a network interface 340 that communicates through a wired 342 and/or wireless 344 connection to a network/server 346 and/or a cloud-based network (computing infrastructure) 348 through the internet. The software/programming instructions for operating a particular quoting node (e.g., 322) may be contained within the node 322 itself and/or the software/programming instructions for operating a particular quoting node 322′, 322″ may be in the cloud 348, with those quoting nodes 322′, 322″ logging-in to the connectivity services pricing/quoting system through the internet 350. Either way, the quoting nodes 322, 322′, 322″ can easily and automatically communicate to carry out the pricing and quoting of connectivity services as discussed above relative to FIGS. 1-3.

FIG. 5 illustrates an example of non-transitory computer readable storage media, employed in the execution of automated pricing and quoting for service connectivity from various service providers. The exemplary non-transitory computer readable storage media 400 may be suitable for use to store instructions or data that creates the instructions that cause an apparatus, such as any of the devices, components and/or systems described herein, in response to execution of the instructions by the device, components and/or system to practice selected aspects of the present invention. The non-transitory computer readable storage media 400 may include a number of programming instructions that are stored on local devices and/or in the cloud.

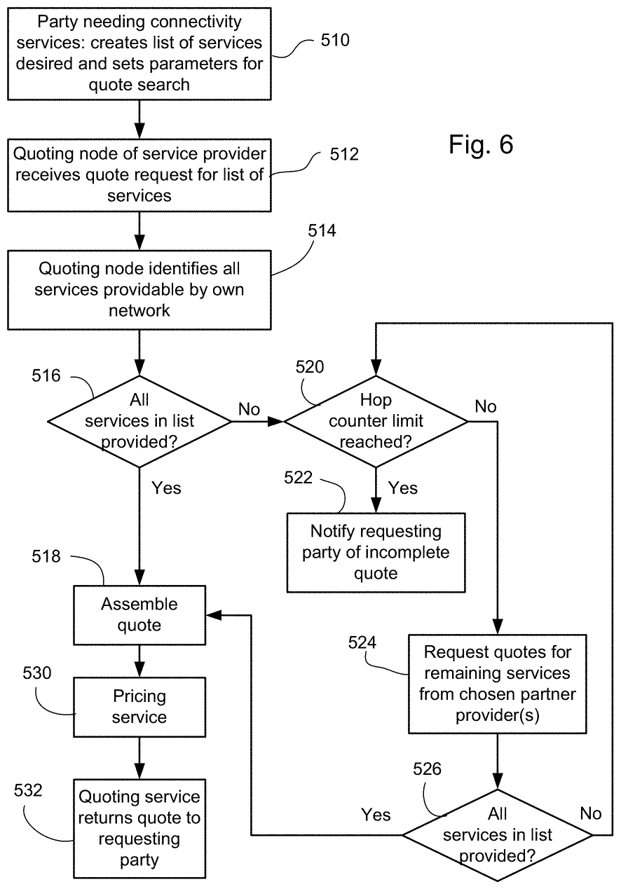

FIG. 6 illustrates an example of process steps relating to operations of quoting node(s). A party (such as the parties discussed relative to FIGS. 1-3 and/or other quoting nodes) requesting connectivity services may provide a list of the services desired and may set parameters for the pricing and quote search, step 510, and forward these to a quoting node (such as those discussed relative to FIGS. 1-4) of an connectivity service provider, step 512. This service provider may be a virtual service provider and/or one with its own network—either way, providing coverage over a particular geographic area. The service provider of this quoting node automatically determines all of the requested services that can be provided with its network (whether virtual or its own network), step 514. If the service provider of this quoting node can provide all of the requested services, step 516, then the service provider automatically proceeds to producing a quote, step 518.

If the service provider of this quoting node is not able to provide all of the services requested, step 516, then the hop counter is compared to a limit, step 520. If the hop counter limit is reached, then the party needed the connectivity services is notified of an inability to furnish a quote for the specified service or portion of the service, step 522. If the hop counter limit is not reached, then the quoting node for the service provider automatically determines what other partner service provider(s) to contact that may provide the remaining connectivity services that the service provider is unable to provide and requests quote(s) from partner provider(s), step 524. If all requested services from the party can be provided by the service provider and partner provider, step 526, then the process automatically proceeds to producing a quote, step 518. If not, then the hop counter is again compared to the limit, step 520, and if the hop counter has not reached its limit, the partner provider automatically determines what other partner service provider(s) to contact that may provide the remaining connectivity services that the partner provider is unable to provide, step 524. This process automatically repeats until the hop counter limit is reached or all of the party's requested services are able to be met.

When the quoting for the complete connectivity requested by the party is met, the price quote is automatically assembled, step 518; automatically sent to a pricing service, step 530, which may for example automatically determine adjustments such as markup of the overall price or other conditions of the quote; and then automatically sends this information to a quoting service, step 532, which automatically returns the quote to the party that requested the connectivity services.

While certain embodiments of the present invention have been described in detail, those familiar with the art to which this invention relates will recognize various alternative designs and embodiments for practicing the invention as defined by the following claims.

1. At least one computer readable medium having instructions stored therein to cause a system, in response to execution of the instructions by at least one processor of the system, to:
receive a request for a quote for connectivity services; and
in response to receipt of the request, facilitate automatic quoting for the connectivity services;
wherein to facilitate includes to:
determine what portion of the connectivity services a service provider can provide and at what price;
request from a first partner provider, chosen by the service provider and capable of interconnecting with the service provider, a first quote for a first remainder of the connectivity services that are not part of the portion that the service provider can provide;
request from a second partner provider, chosen by the first partner provider and capable of interconnecting with the first partner provider, a second quote for a second remainder of the connectivity services that are not part of the first remainder of the connectivity services;
return a combined quote from the first and second partner providers to the service provider; and
combine the quote from the service provider and the combined quote to produce a total quote for the connectivity services and communicate the combined quote to a party requesting the quote for connectivity services.

2. The at least one computer readable medium of claim 1, wherein to facilitate further includes to:
request from a third partner provider, chosen by the second partner provider and capable of interconnecting with the first partner provider, a third quote for a third remainder of the connectivity services that are not part of the second remainder of the connectivity services;
return a combination quote from the first, second and third partner providers to the service provider; and
combine the quote from the service provider and the combination quote to produce an overall quote for the connectivity services and communicate the overall quote to the party requesting the quote for connectivity services.

3. The at least one computer readable medium of claim 2, wherein the overall quote is not communicated to the party requesting the connectivity services if a hop count limit is exceeded before a quote that covers all of the connectivity services requested is achieved.

4. The at least one computer readable medium of claim 3, wherein at least one of the service provider, the first partner provider, the second partner provider and the third partner provider are virtual connectivity providers.

5. The at least one computer readable medium of claim 3, wherein the service provider, the first partner provider, the second partner provider and the third partner provider each provide connectivity services over geographically distinct areas.

6. The at least one computer readable medium of claim 5, wherein the first partner provider is geographically adjacent to and interconnected with a network of the service provider, the second partner provider is geographically adjacent to and interconnected with a network of the first partner provider, and the third partner provider is geographically adjacent to and interconnected with a network of the second partner provider.

7. The at least one computer readable medium of claim 1, wherein at least one of the service provider, the first partner provider and the second partner provider are virtual connectivity providers.

8. The at least one computer readable medium of claim 1, wherein the service provider, the first partner provider and the second partner provider each provide connectivity services over geographically distinct areas.

9. The at least one computer readable medium of claim 8, wherein the first partner provider is geographically adjacent to and interconnected with a network of the service provider and the second partner provider is geographically adjacent to and interconnected with a network of the first partner provider.

10. A system comprising:
a quoting node configured to automatically receive a quote request from a party for connectivity services and automatically determine what geographic portion of the connectivity services a service provider for this quoting node can provide;
a second quoting node configured to automatically receive a request, automatically sent from the quoting node if the service provider cannot provide connectivity services for all of the connectivity services requested, for a quote from a first partner provider for a remaining geographic portion of the connectivity services that are not provided by the service provider;
a third quoting node configured to automatically receive a request, automatically sent from the second quoting node if the first partner provider cannot provide connectivity services for all of the remaining connectivity services requested, for a quote from a second partner provider for a second remaining geographic portion of the connectivity services that are not provided by the service provider or the first partner provider; and
wherein the second quoting node is configured to automatically send a combined quote for connectivity services for the remaining geographic portion to the quoting node when the first partner provider or the first and second partner providers combined can provide the all of the remaining connectivity services that the service provider cannot provide; and wherein the quoting node automatically returns an overall quote to the party for connectivity services when all of the connectivity services requested by the party can be provided.

11. The system of claim 10 wherein at least one of the service provider, the first partner provider and the second partner provider are virtual connectivity providers.

12. The system of claim 10 wherein the quoting node is configured so that the overall quote is not automatically communicated to the party requesting the connectivity services if a hop count limit is exceeded before a quote that covers all of the connectivity services requested is achieved.

13. The system of claim 10 wherein the first partner provider is geographically adjacent to and interconnected with a network of the service provider, and the second partner provider is geographically adjacent to and interconnected with a network of the first partner provider.

14. A method of quoting connectivity services, comprising:
a quoting node automatically receiving a quote request from a party for connectivity services and automatically determining what geographic portion of the connectivity services a service provider for this quoting node can provide;
a second quoting node automatically receiving a request, automatically sent from the quoting node if the service provider cannot provide connectivity services for all of the connectivity services requested, for a quote from a first partner provider for a remaining geographic portion of the connectivity services that are not provided by the service provider;
a third quoting node automatically receiving a request, automatically sent from the second quoting node if the first partner provider cannot provide connectivity services for all of the remaining connectivity services requested, for a quote from a second partner provider for a second remaining geographic portion of the connectivity services that are not provided by the service provider or the first partner provider; and
wherein the second quoting node automatically sends a combined quote for connectivity services for the remaining geographic portion to the quoting node when the first partner provider or the first and second partner providers combined can provide the all of the remaining connectivity services that the service provider cannot provide; and wherein the quoting node automatically returns an overall quote to the party for connectivity services when all of the connectivity services requested by the party can be provided.

15. The method of claim 14 wherein at least one of the service provider, the first partner provider and the second partner provider are virtual connectivity providers.

16. The method of claim 14 wherein the overall quote is not automatically communicated to the party requesting the connectivity services if a hop count limit is exceeded before a quote that covers all of the connectivity services requested is achieved.

17. The method of claim 14 wherein the first partner provider is geographically adjacent to and interconnected with a network of the service provider, and the second partner provider is geographically adjacent to and interconnected with a network of the first partner provider.
